(19) United States
(12) Patent Application Publication
(10) Pub. No.: US 2012/0206192 A1
(43) Pub. Date: Aug. 16, 2012

(54) PROGRAMMABLE BANDGAP VOLTAGE REFERENCE

(76) Inventors: Jay B. Fletcher, Austin, TX (US); Steven C. Meyers, Round Rock, TX (US)

(21) Appl. No.: 13/027,495

(22) Filed: Feb. 15, 2011

(51) Int. Cl. G05F 1/10

(52) U.S. Cl. 327/539

(57) ABSTRACT

A bandgap reference circuit includes an amplifier configured to provide an output voltage dependent upon voltages appearing at an inverting input and a non-inverting input. The bandgap reference circuit also includes a first transistor coupled between the non-inverting input and a circuit ground reference, and a first resistor coupled to the inverting input. The bandgap reference circuit also includes a number of second transistors coupled in parallel between the circuit ground reference and the first resistor. At least a portion of the second transistors are connected to the first resistor through a plurality of programmably selectable switches.

### BACKGROUND

1. Technical Field

This disclosure relates to integrated circuits and, more particularly, to bandgap voltage reference circuits.

2. Description of the Related Art

Many integrated circuits require the use of a voltage reference. One popular type of voltage reference is a bandgap voltage reference. The bandgap voltage reference is usually referred to as a temperature independent voltage reference. A bandgap voltage reference combines two internal voltage sources each with a different temperature coefficient, so that when added together, the temperature dependence cancels. Although bandgap voltage references are widely used, they do have drawbacks.

More particularly, one such drawback is that as manufacturing processes vary from an ideal model, the output voltage of the bandgap voltage reference may not be predictable across temperature. Accordingly, in some cases, an integrated circuit design may have to go back for a revision to modify the size of one or more of the transistors or diodes that have temperature dependencies. In other cases, resistor ratios may be altered using laser trimming techniques or mask revisions to the design. In either case, these changes can be costly.

### SUMMARY OF THE EMBODIMENTS

Various embodiments of a bandgap voltage reference circuit are disclosed. In one embodiment, the bandgap reference circuit includes an operational amplifier that may be configured to provide an output voltage dependent upon voltages appearing at an inverting input and a non-inverting input. The bandgap reference circuit also includes a first transistor coupled between the non-inverting input and a circuit ground reference, and a first resistor coupled to the inverting input. The bandgap reference circuit also includes a number of second transistors coupled in parallel between the circuit ground reference and the first resistor. At least a portion of the second transistors are connected to the first resistor through a plurality of programmably selectable switches.

In one specific implementation, each of the programmably selectable switches may be configured to switch a different number of the second transistors.

In another specific implementation, each of the programmably selectable switches may be controlled by writing to register.

In another embodiment, the bandgap reference circuit includes an operational amplifier configured to provide an output voltage dependent upon voltages appearing at an inverting input and a non-inverting input. The bandgap reference circuit also includes a first diode coupled between the non-inverting input and a circuit ground reference, and a first resistor coupled to the inverting input. The bandgap reference circuit also includes a number of second diodes coupled in parallel between the circuit ground reference and the first resistor. At least a portion of the second diodes are connected to the first resistor through a plurality of programmably selectable switches.

### BRIEF DESCRIPTION OF THE DRAWINGS

FIG. 1 is a circuit diagram of one embodiment of a programmable bandgap voltage reference circuit.

FIG. 2 is a block diagram of an embodiment of a system having an integrated circuit including the programmable bandgap voltage reference circuit of FIG. 1.

FIG. 3 is a block diagram of a computer accessible storage medium including a circuit database.

Specific embodiments are shown by way of example in the drawings and will herein be described in detail. It should be understood, however, that the drawings and detailed description are not intended to limit the claims to the particular embodiments disclosed, even where only a single embodiment is described with respect to a particular feature. On the contrary, the intention is to cover all modifications, equivalents and alternatives that would be apparent to a person skilled in the art having the benefit of this disclosure. Examples of features provided in the disclosure are intended to be illustrative rather than restrictive unless stated otherwise.

As used throughout this application, the word “may” is used in a permissive sense (i.e., meaning having the potential to), rather than the mandatory sense (i.e., meaning must). Similarly, the words “include,” “including,” and “includes” mean including, but not limited to.

Various units, circuits, or other components may be described as “configured to” perform a task or tasks. In such contexts, “configured to” is a broad recitation of structure generally meaning “having circuitry that” performs the task or tasks during operation. As such, the unit/circuit/component can be configured to perform the task even when the unit/circuit/component is not currently on. In general, the circuitry that forms the structure corresponding to “configured to” may include hardware circuits. Similarly, various units/circuits/components may be described as performing a task or tasks, for convenience in the description. Such descriptions should be interpreted as including the phrase “configured to.” Reciting a unit/circuit/component that is configured to perform one or more tasks is expressly intended not to invoke 35 U.S.C. §112, paragraph six, interpretation for that unit/circuit/component.

### DETAILED DESCRIPTION

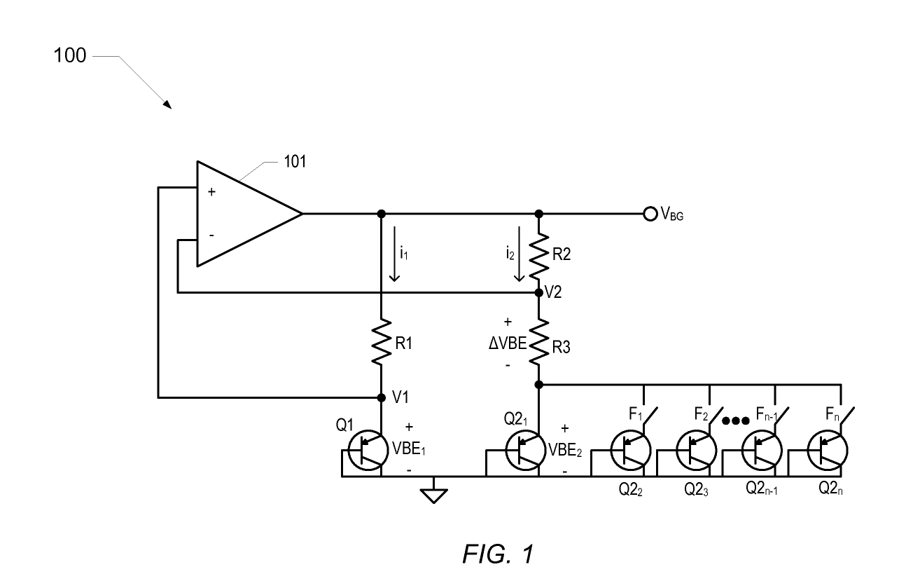

Turning now to FIG. 1, a circuit diagram of one embodiment of a programmable bandgap voltage reference circuit is shown. The programmable bandgap voltage reference (BGV) circuit 100 includes an operational amplifier (opamp) circuit 101, the output of which is the reference voltage V_{BG}. The BGV circuit 100 also includes resistors R1 through R3, a transistor Q1 and a number of transistors Q2. In the illustrated embodiment, transistor Q1 and transistors Q2 are bipolar junction transistors. As shown, the collector and the base of transistor Q1 are coupled to the circuit ground reference. The emitter is coupled to one terminal of resistor R1. The other terminal of resistor R1 is coupled to the output of the opamp 101. The inverting input of opamp 101 is coupled to a node between the resistor R1 and the emitter of Q1. Similarly, the collectors and the bases of transistors Q2 are coupled to the circuit ground reference. The emitter of Q2₁ is coupled to one terminal of resistor R3. The other terminal of resistor R3 is coupled to one terminal of resistor R2, and other terminal of resistor R2 is coupled to the output of the opamp 101. The non-inverting input of opamp 101 is coupled to a node between the resistor R2 and the resistor R3. In addition, the emitter of each of transistors Q2₂ through Q2ₙ are coupled through respective switches F₁ through Fₙ to a node between the emitter of transistor Q2₁ and resistor R3.

As mentioned above, a bandgap reference circuit such as BGV 100 circuit operates by combining two internal voltage sources each with a different temperature coefficient, so that when added together, the temperature dependence cancels. More particularly, the near-temperature-independent behavior of the bandgap output voltage V_{BG} is achieved by appropriately choosing a weighted sum of ΔV_{BE} (with a voltage characteristic that is proportional to absolute temperature or “PTAT”) and V_{BE2} (with a voltage characteristic that is complementary to absolute temperature or “CTAT”) using a ratio of current densities of the PN junctions of the transistors Q1 and Q2 such that the PTAT behavior compensates for the CTAT behavior.

The voltage V_{BE2} refers to the voltage across the base emitter junction of Q21. The temperature coefficient of a PN junction is negative, as mentioned above in regard to the CTAT. The voltage ΔV_{BE} (i.e., V_{BE1}−V_{BE2}) which appears across resistor R3 has a positive temperature coefficient, or PTAT. For an ideal opamp, the voltages at the inverting and non-inverting inputs of opamp 101 are maintained to be the same, thus V₁ equals V₂. The derivation of Δ_{BE} is below. Since V1=V2 and

V₁=V_{BE1}, and (1)

V₂=V_{BE2}i2*R3, then (2)

V_{BE1}=V_{BE2}+i₂*R3. Thus, (3)

V_{BE1}−V_{BE2}=i₂*R3, and thus (4)

ΔV_{BE}=i₂*R3. (5)

The reference voltage V_{BG} may be expressed as follows:

$$\begin{matrix}{V}_{BG} = {i}_{2} * R 2 + {V}_{2} , & ( 6 ) \\ {V}_{BG} = {i}_{2} * R 2 + {V}_{BE 2} + i 2 * R 3 , & ( 7 ) \\ {V}_{BG} = {i}_{2} ( R 2 + R 3 ) + {V}_{BE 2} , & ( 8 ) \\ {V}_{BG} = Δ {V}_{BE} ( 1 + \frac{R 2}{R 3} ) + {V}_{BE 2} & ( 9 )\end{matrix}$$

As described above, the voltage ΔV_{BE} is PTAT and may be expressed as

V_{T} ln(PiPd), where (10)

Pi is the ratio of currents i₁ and i₂, and is expressed as

$$Pi = \frac{{i}_{1}}{{i}_{2}} , and \qquad ( 11 )$$

Pd is the ratio of the area of the PN junction of the transistors and is expressed as the ratio of the number of transistors as follows

$$Pd = \frac{nQ 2}{nQ 1} , and \qquad ( 12 )$$

the term Pi*Pd is the current density.

Thus, the reference voltage may be expressed as

$${V}_{BG} = {V}_{BE 2} + {V}_{T} ln ( Pi \cdot Pd ) ( 1 + \frac{R 2}{R 3} ) , \qquad ( 13 )$$

where V_{T} is the thermal voltage associated with a PN junction and may be expressed as

$${V}_{T} = \frac{kT}{q} . \qquad ( 14 )$$

As described above, in some conventional bandgap reference circuits, the resistors may be laser trimmed to accommodate process variations. However, this can be time consuming and costly. As shown in FIG. 1, the BGV circuit 100 includes a number of transistors Q2 that may be programmably switched into or out of the circuit. More particularly, as shown in equation 13 above, the Pd term also affects the PTAT term ΔV_{BE}. Accordingly, after the integrated circuit is fabricated, if the voltage V_{BG} does not exhibit the desired temperature independence, then the number of transistors (i.e., PN junctions) and thus the current density of the PTAT, may be changed to affect the voltage vs. temperature curve for V_{BG}, which should be as flat as possible.

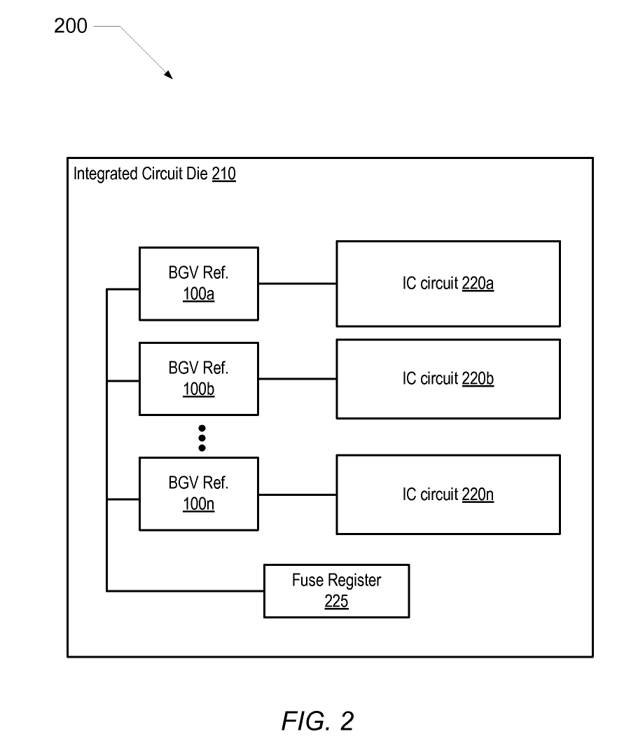

Accordingly, as shown in FIG. 1, each of the transistors Q2₂ through Q2ₙ is coupled to the node between R3 and Q2₁ through a respective switch F₁-Fₙ. In one embodiment, the switches F₁-Fₙ may be programmed to be open or closed. More particularly, in one implementation, the BGV 100 may be designed and fabricated with a predetermined number of these switches closed to achieve a particular Pd ratio. That predetermined number may be obtained through SPICE simulation, for example. However, after the IC is fabricated and tested across various temperatures, the V_{BG} may not have the desired voltage response over temperature due to various process variables. To fix the problem, in one embodiment, a special mode such as a test mode may be entered and one or more fuse registers (shown in FIG. 2) may be accessed through software. These fuse registers may be written with a particular value that changes the number of switches that are open or closed, which changes the number of Q2 transistors, thereby changing the Pd term in equation 13. It is noted that the fuse register settings may be permanent or non-permanent as desired.

In one embodiment, the switches F₁-Fₙ may be weighted such that a given switch may switch one number of transistors in and out of the circuit, while another switch may switch a different number of transistors. For example, in one implementation, the switches may be 2ⁿ encoded such that transistor Q2₂ may be representative of one transistor, transistor Q2₃ may be representative of two transistors, and transistor Q2ₙ may be representative of 32 transistors or some other 2ⁿ number. In an alternative embodiment each switch may switch one transistor in and out of the circuit. In either embodiment, various combinations of transistors may be added to or removed from the BGV circuit 100. In various embodiments each of the switches F₁-Fₙ may be implemented as a transistor, a fuse, or other type of device that may be programmably configured to conduct current or to cut off current flow.

It is noted that since the equations given above pertain to PN junctions, in another embodiment, the transistors used in BGV circuit 100 may be replaced with diodes. More particularly, depending on the semiconductor process, it may not be feasible to fabricate a bipolar junction transistor (BJT). For example, in a silicon-on-insulator (SOI) process, instead of stacked BJTs, diodes may be used. In such embodiments, instead of referring to the base-emitter voltage V_{BE}, the forward voltage of the diode or V_{D}, for example, may be used.

It is also noted that although the above embodiment of a bandgap voltage reference circuit has a particular topology, it is contemplated that other bandgap reference voltage circuit topologies may use multiple programmably selected transistors or diodes to affect ratio of the area of the PN junction of the transistors and thus the current density of the ΔV_{BE} term in equation 13.

Referring to FIG. 2, a block diagram of a system including an integrated circuit die having an embodiment of the bandgap voltage reference circuit 100 of FIG. 1 is shown. The system 200 includes an IC die 210 with a plurality of BGV reference circuits designated 100a, 100b and 100n, where n may be any number. The IC die 210 also includes a plurality of IC circuits designated 220a, 220b, and 220m, where m may be any number. The IC dies also includes a fuse register 225 that is coupled to each of the BGV reference circuits 100. Each BGV circuit 100 in FIG. 2 is coupled to provide a reference voltage to a respective IC circuit 220. For example, the BGV circuit 100a is coupled to IC circuit 220a, and so on. It is noted that in one embodiment, each of the BGV circuits 100 in FIG. 2 may be identical to the BGV circuit 100 of FIG. 2, although as mentioned above, in other embodiments, the transistors in FIG. 1 may be replaced with diodes. It is further noted that although IC die 210 may be any type of integrated circuit, it is contemplated that in one embodiment the IC die 210 may embody a microprocessor, a graphics processor, or processing node having multiple microprocessors and/or graphics processors manufactured thereon.

As described above, the number of transistors or diodes that were fabricated to be active in each BGV circuit 100 may be changed during operation in a test mode through the use of the fuse registers 225. In one embodiment, the fuse registers 225 may cause one or more soft fuses to be connected or disconnected. In addition, the soft fuse connections that are programmed may be repaired or bypassed via one or mechanisms such as a multiplexer, for example. In other embodiments, the fuse registers 225 may cause one or more hard fuses to be “blown.” The hard fuses typically may not be undone once connected or disconnected. In yet other embodiments, the fuse registers 225 may simply enable or disable one or more switching transistors that may be representative of switches F₁-Fₙ.

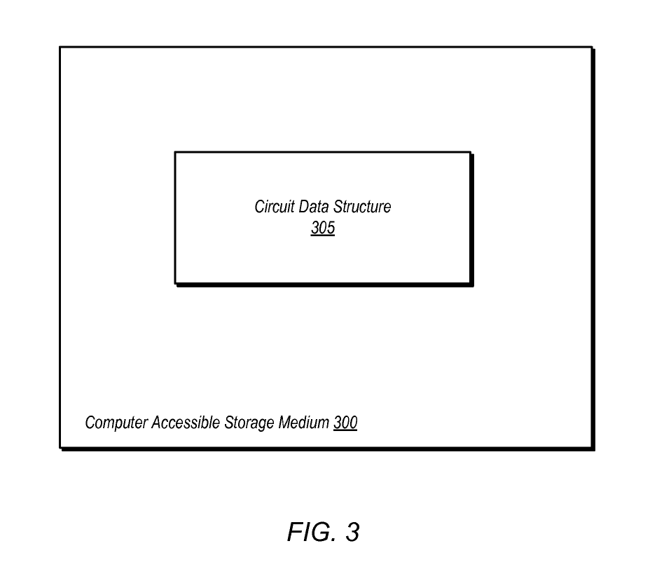

Turning to FIG. 3, a block diagram of a computer accessible storage medium 300 including a circuit database 305 that is representative of at least portions of the IC 210 of FIG. 2 is shown. Generally speaking, a computer accessible storage medium 300 may include any non-transitory storage media accessible by a computer during use to provide instructions and/or data to the computer. For example, a computer accessible storage medium 300 may include storage media such as magnetic or optical media, e.g., disk (fixed or removable), tape, CD-ROM, or DVD-ROM, CD-R, CD-RW, DVD-R, DVD-RW, or Blu-Ray. Storage media may further include volatile or non-volatile memory media such as RAM (e.g. synchronous dynamic RAM (SDRAM), double data rate (DDR, DDR2, DDR3, etc.) SDRAM, low-power DDR (LPDDR2, etc.) SDRAM, Rambus DRAM (RDRAM), static RAM (SRAM), etc.), ROM, Flash memory, non-volatile memory (e.g. Flash memory) accessible via a peripheral interface such as the Universal Serial Bus (USB) interface, etc. Storage media may include microelectromechanical systems (MEMS), as well as storage media accessible via a communication medium such as a network and/or a wireless link.

Generally, the database 305 of the IC 210 carried on the computer accessible storage medium 300 may be a database or other data structure which can be read by a program and used, directly or indirectly, to fabricate the hardware comprising the IC 210. For example, the database 305 may be a behavioral-level description or register-transfer level (RTL) description of the hardware functionality in a high level design language (HDL) such as Verilog or VHDL. The description may be read by a synthesis tool which may synthesize the description to produce a netlist comprising a list of gates from a synthesis library. The netlist comprises a set of gates which also represent the functionality of the hardware comprising the IC 210. The netlist may then be placed and routed to produce a data set describing geometric shapes to be applied to masks. The masks may then be used in various semiconductor fabrication steps to produce a semiconductor circuit or circuits corresponding to the IC 210. Alternatively, the database 305 on the computer accessible storage medium 300 may be the netlist (with or without the synthesis library) or the data set, as desired.

While the computer accessible storage medium 300 carries a representation of the IC 210, other embodiments may carry a representation of any portion of the IC 210, such as one of the BGV circuits 100, as desired.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A bandgap reference circuit comprising:
a first transistor coupled to a circuit ground reference and configured to develop a first junction voltage;
a plurality of second transistors selectably coupled together in parallel and to the circuit ground reference and configured to develop a second junction voltage; and
an output circuit configured to provide an output reference voltage dependent upon a voltage difference between the first junction voltage and the second junction voltage;
wherein at least a portion of the second transistors are configured to be selectively connected together through a plurality of programmably selectable switches.

2. The bandgap reference circuit as recited in claim 1, wherein each of the plurality of programmably selectable switches is configured to switch a different number of the second transistors.

3. The bandgap reference circuit as recited in claim 1, wherein each of the plurality of programmably selectable switches is controlled by a value in a register.

4. The bandgap reference circuit as recited in claim 1, wherein the plurality of programmably selectable switches are accessible in a test mode.

5. The bandgap reference circuit as recited in claim 1, wherein each of the plurality of programmably selectable switches is controlled by a respective hard fuse.

6. The bandgap reference circuit as recited in claim 1, wherein each of the second transistors includes an emitter, a base and a collector, wherein the emitter is coupled to a the output circuit through first resistor, and the base and collector are couple to the circuit ground reference.

7. The bandgap reference circuit as recited in claim 6, further comprising a second resistor coupled between an output of the output circuit and the first resistor.

8. The bandgap reference circuit as recited in claim 1, wherein the output circuit comprises an operational amplifier.

9. The bandgap reference circuit as recited in claim 1, wherein the voltage difference is proportional to a number of the second transistors that are connected together through the plurality of programmably selectable switches.

10. A bandgap reference circuit comprising:
a first diode configured to develop a first junction voltage;
a plurality of second diodes selectably coupled together in parallel and to a circuit ground reference and configured to develop a second junction voltage;
an output circuit configured to provide an output reference voltage dependent upon a voltage difference between the first junction voltage and the second junction voltage;
wherein at least a portion of the second diodes are connected to the first resistor through a plurality of programmably selectable switches.

11. The bandgap reference circuit as recited in claim 10, wherein each of the plurality of programmably selectable switches is configured to switch a different number of the second diodes.

12. The bandgap reference circuit as recited in claim 10, wherein each of the plurality of programmably selectable switches is controlled by a value in a register.

13. The bandgap reference circuit as recited in claim 10, wherein the output circuit comprises an operational amplifier.

14. The bandgap reference circuit as recited in claim 10, wherein the voltage difference is proportional to a number of the second diodes that are connected to the first resistor through the plurality of programmably selectable switches.

15. An integrated circuit device comprising:
one or more circuits; and
one or more reference voltage circuits, each coupled to provide an output reference voltage to a respective one of the one or more circuits, wherein each reference voltage circuit includes:
a first transistor coupled to a circuit ground reference and configured to develop a first junction voltage;
a plurality of second transistors selectably coupled together in parallel and to the circuit ground reference and configured to develop a second junction voltage;
an output circuit configured to provide an output reference voltage dependent upon a voltage difference between the first junction voltage and the second junction voltage;
wherein at least a portion of the second transistors are connected together through a plurality of programmably selectable switches.

16. The integrated circuit device as recited in claim 15, wherein each of the plurality of programmably selectable switches is controlled by writing to register.

17. The integrated circuit device as recited in claim 15, wherein each of the plurality of programmably selectable switches is configured to switch a different number of the second transistors.

18. The integrated circuit device as recited in claim 15, wherein each of the plurality of programmably selectable switches is configured to switch one of the second transistors.

19. A computer readable medium storing a data structure which is operated upon by a program executable on a computer system, the program operating on the data structure to perform a portion of a process to fabricate an integrated circuit including circuitry described by the data structure, the circuitry described in the data structure including:
a first transistor coupled to a circuit ground reference and configured to develop a first junction voltage;
a plurality of second transistors selectably coupled together in parallel and to the circuit ground reference and configured to develop a second junction voltage;
an output circuit configured to provide an output reference voltage dependent upon a voltage difference between the first junction voltage and the second junction voltage;
wherein at least a portion of the second transistors are connected together through a plurality of programmably selectable switches.

20. The computer readable medium as recited in claim 19, wherein each of the plurality of programmably selectable switches is configured to switch a different number of the second transistors.
